(19) United States
(12) Patent Application Publication
(10) Pub. No.: US 2010/0149426 A1
(43) Pub. Date: Jun. 17, 2010

(54) SYSTEMS AND METHODS FOR BANDWIDTH OPTIMIZED MOTION COMPENSATION MEMORY ACCESS

(76) Inventors: Ho-Tzu Cheng, Hsinchu (TW); Jung-Chien Hsu, Hsinchu (TW)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/336,763

(22) Filed: Dec. 17, 2008

(51) Int. Cl. H04N 9/64; G06F 13/00

(52) U.S. Cl. 348/714; 711/154; 348/E09.037

(57) ABSTRACT

In one exemplary embodiment, methods and systems are disclosed for providing access to video data. The disclosed methods and systems comprise providing a memory device having a plurality of memory areas, and receiving a data sequence containing the video data of a plurality of blocks of a video image frame. The methods and systems also comprise storing the video data in the memory device by allocating a plurality of pixel data groups along a frame-width direction in consecutive memory-addressing areas, and allowing access to the video data in response to a data access request.

### TECHNICAL FIELD

The present disclosure relates generally to systems and methods for optimized memory access and, more particularly, to systems and methods for bandwidth optimized motion compensation memory access.

### BACKGROUND

H.264/AVC is a next generation video coding standard developed by the Joint Video Team (JVT), which includes experts from the ITU-T Video Coding Experts Group (VCEG) and ISO/IEC Moving Picture Experts Group (MPEG). Because H.264/AVC supports several high efficiency coding tools, it is able to achieve gains in compression efficiency over a wide range of bit rates and video resolutions compared to previous standards. For example, H.264/AVC video coding may be capable of 39% bit rate reduction compared to MPEG-4 video coding, 49% bit rate reduction compared to H.263 video coding, and 64% bit rate reduction compared to MPEG-2 video coding. As a result, however, an H.264/AVC video decoder may be more complex. Consequently, in the VLSI design and implementation of the H.264/AVC decoder, off-chip memory access requires more time and consume more power.

In an H.264/AVC video decoder, there are four main modules that require off-chip memory access: motion compensation, reference picture buffer, de-blocking, and display feeder. In particular, motion compensation in an H.264/AVC video decoder may access off-chip memory at a ratio of about 75% greater than the other three modules. Thus, motion compensation becomes the main memory access bottleneck of an H.264/AVC video decoder.

Similarly to other major coding standards, the H.264/AVC video coding standard adopts block-based motion compensation. Different from the other major coding standards, however, H.264/AVC supports variable block size (e.g., 16×16, 16×8, 8×16, 8×8, 8×4, 4×8, and 4×4) and quarter-pixel (¼ pel) motion vectors. To create sub-pixel motion vectors during motion compensation, each partition in an inter-coded macro block is predicted from an area of the same size in a reference picture. Because the luma and chroma samples at sub-pixel positions do not exist in the reference picture, they may be created through interpolation using nearby image samples.

Generally, the first step in interpolating sub-pixel samples is to generate half-pixel samples of the luma component of the reference picture. For example, each half-pixel sample that is adjacent to two full-pixel samples may be interpolated from full-pixel samples using a 6-tap Finite Impulse Response (FIR) filter( 1/32, − 5/32, 20/32, 20/32, − 5/32, 1/32). Once all of the sub-pixel samples adjacent to full-pixel samples have been calculated, the remaining half-pixel positions are calculated by interpolating between six horizontal or vertical half-pixel samples from the first set of operations. When all the half-pixel samples are available, the quarter-pixel positions are produced by linear interpolation.

In order to interpolate an M×N luma portion, where M is the width and N is the height of current partition, an (M+5)×(N+5) reference data block is required to be read from off-chip memory. Thus, due to the combined effect of, for example, a smaller block size (e.g., 4×4) and the 6-tap interpolation filter, a large number of frame memory accesses are required during luma quarter pixel interpolation.

The disclosed embodiments are directed to overcoming one or more of the problems set forth above.

### SUMMARY OF THE INVENTION

In one exemplary embodiment, the present disclosure is directed to a method for providing access to video data, comprising: providing a memory device having a plurality of memory areas; receiving a data sequence containing the video data of a plurality of blocks of a video image frame; storing the video data in the memory device by allocating a plurality of pixel data groups along a frame-width direction in consecutive memory-addressing areas; and allowing access to the video data in response to a data access request.

In another exemplary embodiment, the present disclosure is directed to a system for providing access to video data, comprising: a memory device having a plurality of memory areas; a data-receiving interface configured to receive a data sequence containing the video data of a plurality of blocks of a video image frame; and a memory controller coupled with the data-receiving interface and the memory device, the memory controller being configured to store the video data in the memory device by allocating pixel data groups along a frame-width direction in consecutive memory-addressing areas.

### BRIEF DESCRIPTION OF THE DRAWINGS

FIG. 1 is a block diagram of an exemplary motion compensation system, consistent with certain disclosed embodiments;

FIG. 2 is a block diagram of an exemplary motion compensation system for storing pixel data, consistent with certain disclosed embodiments;

FIG. 3a is a block diagram illustrating an exemplary memory access, consistent with certain disclosed embodiments;

FIG. 3b is a block diagram illustrating an exemplary memory access, consistent with certain disclosed embodiments;

FIG. 3c is a block diagram illustrating an exemplary memory access, consistent with certain disclosed embodiments;

FIG. 3d is a block diagram illustrating an exemplary memory access, consistent with certain disclosed embodiments;

FIG. 4a is a block diagram illustrating an exemplary 8×8 frame-based memory access, consistent with certain disclosed embodiments;

FIG. 4b is a block diagram illustrating an exemplary 8×8 frame-based memory access, consistent with certain disclosed embodiments;

FIG. 4c is a block diagram illustrating an exemplary 8×8 frame-based memory access, consistent with certain disclosed embodiments;

FIG. 4d is a block diagram illustrating an exemplary 8×8 frame-based memory access, consistent with certain disclosed embodiments;

FIG. 4e is a block diagram illustrating an exemplary 8×8 frame-based memory access, consistent with certain disclosed embodiments;

FIG. 5a is a block diagram illustrating an exemplary 8×8 frame-based memory access, consistent with certain disclosed embodiments;

FIG. 5b is a block diagram illustrating an exemplary 8×8 frame-based memory access, consistent with certain disclosed embodiments;

FIG. 5c is a block diagram illustrating an exemplary 8×8 frame-based memory access, consistent with certain disclosed embodiments;

FIG. 5d is a block diagram illustrating an exemplary 8×8 frame-based memory access, consistent with certain disclosed embodiments;

FIG. 5e is a block diagram illustrating an exemplary 8×8 frame-based memory access, consistent with certain disclosed embodiments;

FIG. 6a is a block diagram illustrating an exemplary 8×8 block-based memory access, consistent with certain disclosed embodiments;

FIG. 6b is a block diagram illustrating an exemplary 8×8 block-based memory access, consistent with certain disclosed embodiments;

FIG. 6c is a block diagram illustrating an exemplary 8×8 block-based memory access, consistent with certain disclosed embodiments;

FIG. 6d is a block diagram illustrating an exemplary 8×8 block-based memory access, consistent with certain disclosed embodiments;

FIG. 6e is a block diagram illustrating an exemplary 8×8 block-based memory access, consistent with certain disclosed embodiments;

FIG. 7a is a block diagram illustrating an exemplary 8×8 block-based memory access, consistent with certain disclosed embodiments;

FIG. 7b is a block diagram illustrating an exemplary 8×8 block-based memory access, consistent with certain disclosed embodiments;

FIG. 7c is a block diagram illustrating an exemplary 8×8 block-based memory access, consistent with certain disclosed embodiments;

FIG. 7d is a block diagram illustrating an exemplary 8×8 block-based memory access, consistent with certain disclosed embodiments;

FIG. 7e is a block diagram illustrating an exemplary 8×8 block-based memory access, consistent with certain disclosed embodiments;

FIG. 7f is a block diagram illustrating an exemplary 8×8 block-based memory access, consistent with certain disclosed embodiments;

FIG. 8a is a block diagram illustrating an exemplary 8×8 block-based memory access, consistent with certain disclosed embodiments;

FIG. 8b is a block diagram illustrating an exemplary 8×8 block-based memory access, consistent with certain disclosed embodiments;

FIG. 8c is a block diagram illustrating an exemplary 8×8 block-based memory access, consistent with certain disclosed embodiments;

FIG. 9a is a block diagram illustrating an exemplary 16×16 block-based memory access, consistent with certain disclosed embodiments;

FIG. 9b is a block diagram illustrating an exemplary 16×16 block-based memory access, consistent with certain disclosed embodiments;

FIG. 9c is a block diagram illustrating an exemplary 16×16 block-based memory access, consistent with certain disclosed embodiments;

FIG. 9d is a block diagram illustrating an exemplary 16×16 block-based memory access, consistent with certain disclosed embodiments;

FIG. 9e is a block diagram illustrating an exemplary 16×16 block-based memory access, consistent with certain disclosed embodiments;

FIG. 9f is a block diagram illustrating an exemplary 16×16 block-based memory access, consistent with certain disclosed embodiments;

FIG. 9g is a block diagram illustrating an exemplary 16×16 block-based memory access, consistent with certain disclosed embodiments;

FIG. 10a is a block diagram illustrating an exemplary 16×16 block-based memory access, consistent with certain disclosed embodiments;

FIG. 10b is a block diagram illustrating an exemplary 16×16 block-based memory access, consistent with certain disclosed embodiments;

FIG. 10c is a block diagram illustrating an exemplary 16×16 block-based memory access, consistent with certain disclosed embodiments;

FIG. 10d is a block diagram illustrating an exemplary 16×16 block-based memory access, consistent with certain disclosed embodiments;

FIG. 10e is a block diagram illustrating an exemplary 16×16 block-based memory access, consistent with certain disclosed embodiments;

FIG. 11a is a block diagram illustrating an exemplary 16×16 block-based memory access, consistent with certain disclosed embodiments;

FIG. 11b is a block diagram illustrating an exemplary 16×16 block-based memory access, consistent with certain disclosed embodiments;

FIG. 11c is a block diagram illustrating an exemplary 16×16 block-based memory access, consistent with certain disclosed embodiments;

FIG. 11d is a block diagram illustrating an exemplary 16×16 block-based memory access, consistent with certain disclosed embodiments; and

FIG. 11e is a block diagram illustrating an exemplary 16×16 block-based memory access, consistent with certain disclosed embodiments.

### DETAILED DESCRIPTION

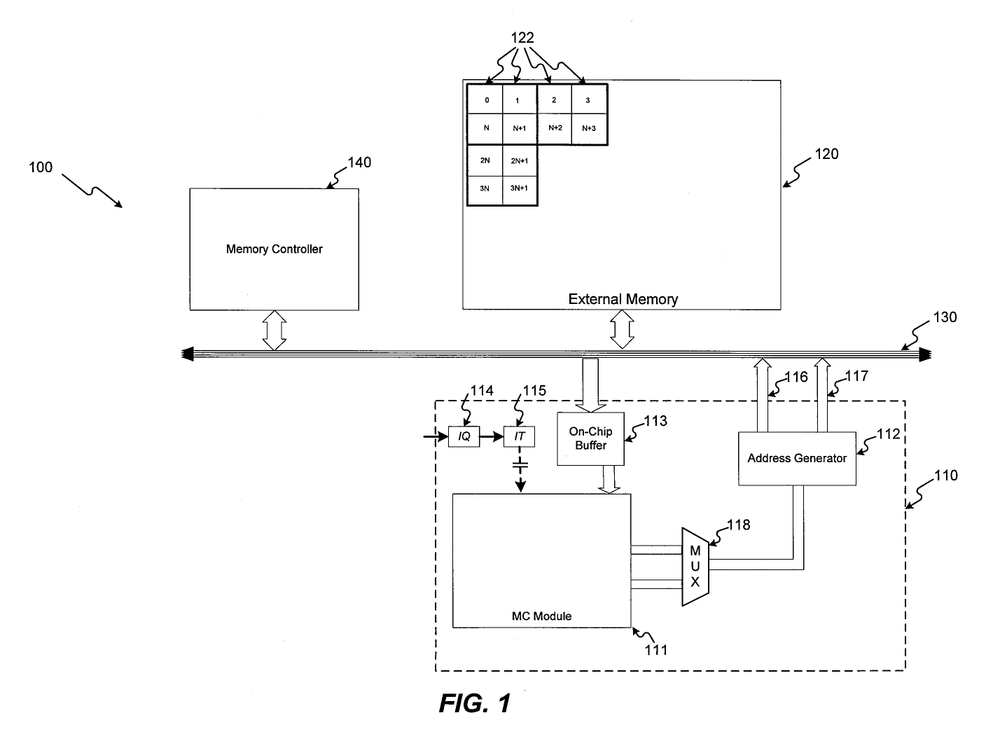

FIG. 1 is a block diagram of an exemplary motion compensation system 100. Exemplary motion compensation system 100 may be based, for example, on the H.264/AVC video coding standard. As shown in FIG. 1, motion compensation system 100 may include a video decoder 110, an external memory 120, a bus 130, and a memory controller 140.

Video decoder 110 may be an integrated circuit, such as, for example, a VLSI circuit, and may be configured to operate according to one or more video coding standards including, for example, an H.264/AVC video coding standard. Video decoder 110 may include a motion compensation (MC) module 111, an address generator 112, an on-chip buffer 113, an inverse quantization (IQ) circuit 114, an inverse transform (IT) circuit 115, an 8×8 data block pipeline 116, a 16×16 data block pipeline 117, and multiplexer (MUX) 118. One of more components of video decoder 110 (e.g., MC module 111, address generator 112, on-chip buffer 113, IQ circuit 114, IT circuit 115, 8×8 data block pipeline 116, 16×16 data block pipeline 117, and MUX 118) may be communicatively coupled with external memory 120 via bus 130.

External memory 120 may be a memory device, including a plurality of separately-addressed memory areas 122. External memory 120 may be configured to store a plurality of data received from video decoder 110. In one exemplary embodiment, external memory 120 may be double data rate (DDR) synchronous dynamic random access memory (SDRAM).

Bus 130 may be configured to transfer data between one or more other components of motion compensation system 100. In one exemplary embodiment, bus 130 may be an Advanced High-performance Bus (AHB). Bus 130 may have a bit bandwidth of a value that is an exponent of 2 (e.g., 2, 4, 6, 8, 16, 32, 64, etc.). In one exemplary embodiment, bus 130 may have a bandwidth of 8 bits. In another exemplary embodiment, bus 130 may have a bandwidth of 16 bits.

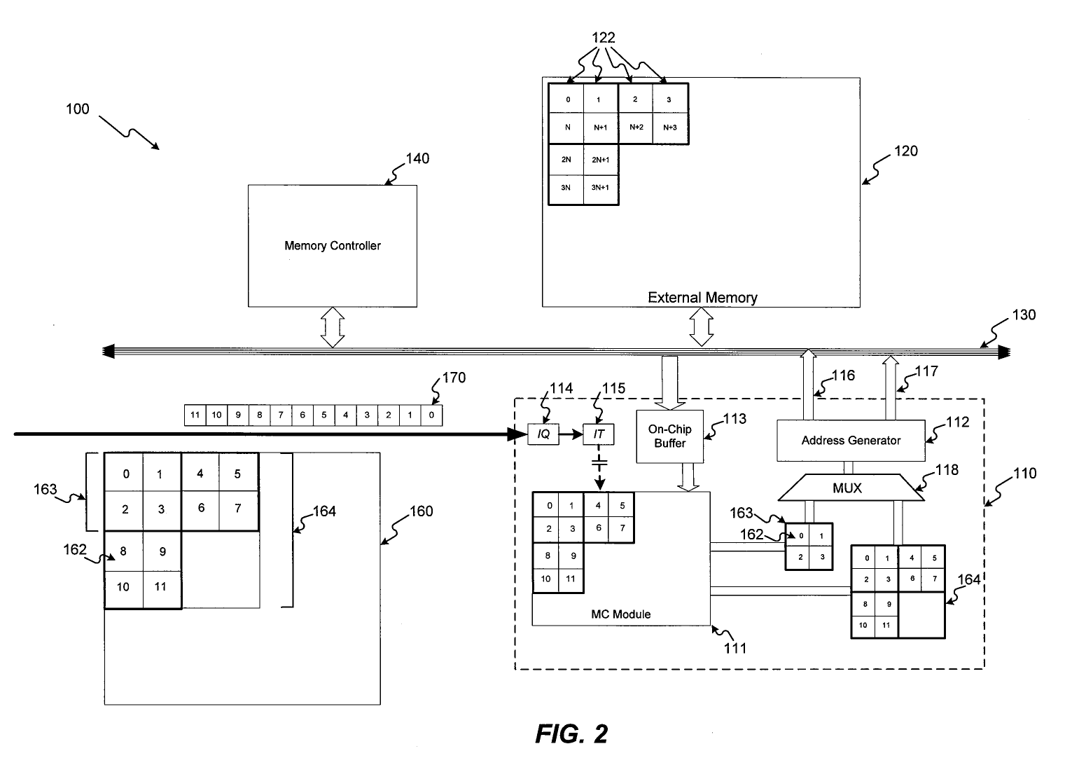

FIG. 2 is a block diagram illustrating memory allocation and storage, consistent with certain disclosed embodiments. As shown in FIG. 2, a data frame 160 may be divided into datablocks of various sizes (e.g., 16×16, 16×8, 8×16, 8×8, 8×4, 4×8, and 4×4). For example, in FIG. 2, data frame 160 may be divided into 4×4 blocks 162, 8×8 blocks 163 (e.g., 0, 1, 2, and 3, 4, 5, 6, and 7, 8, 9, 10, and 1, etc.) or 16×16 macro blocks 164 (e.g., 0, 1, 2, 3, 4, 5, 6, 7, 8, 9, 10, 11, 12, 13, 14, and 15, etc.). As used herein, each numbered 4×4 block (i.e., 0, 1, 2, 3, 4, 5, etc.) may include data for sixteen pixels, and the numbers shown in each 4×4 block are used to represent the address in external memory 120 where the data for those sixteen pixels may be located.

Video decoder 110 may receive, via IQ 114 and IT 115, blocks of any size (e.g., 4×4 block 162, 8×8 block 163, 16×16 macro block 164, etc.). In some embodiments, the block size may be chosen based on a desired block type (i.e., based on an “mbtype”). When IQ 114 and IT 115 receive blocks 162, 163, and macro block 164, IQ 114 and IT 115 may perform inverse quantization and inverse transformation to generate reconstructed data.

After processing by IQ 114 and IT 115, depending on the mbtype, blocks 162, 163, and macro block 164 may be received by MC module 111 for motion compensation processing. As shown in FIG. 2, in one exemplary embodiment, after motion compensation processing of blocks 162, 163, and macro block 164, address generator 112 may begin processing. Address generator 112 may be configured to re-order the 4×4 blocks 162 (e.g., 0, 1, 2, 3, 4, 5, 6, 7, 8, 9, 10, 11, 12, 13, 14, and 15, etc.) such that they are stored sequentially in a frame-width direction in memory areas 122 of external memory 120. In some embodiments, the 4×4 blocks 162 may be reordered from their original order for storage into the memory areas 122 of FIG. 2.

Finally, each 4×4 block 162 may be sent to external memory 120 via bus 130 for storage. In some embodiments, memory controller 140 may control the storage of each 4×4 block 162 in memory areas 122 of external memory 120. As shown in FIG. 2, memory controller 140 may be configured to allocate memory in external memory 120 in either a block-based or a frame-based configuration. For example, when allocating external memory 120 according to a block-based format, memory controller 140 may allocate a plurality of memory areas in external memory 120 on a block-by-block basis (e.g., 4×4 block, 8×8 block, 16×16 macro block, etc.) so that sequentially addressed pixel data is stored in sequentially related memory areas in external memory 120 for any size of the given block. Similarly, when allocating external memory 120 according to a frame-based format, memory controller 140 may allocate a plurality of memory areas in external memory 120 on a frame-by-frame basis (e.g., display image-by-display image, etc.) so that sequentially addressed pixel data are stored in sequentially related memory areas in external memory 120 for any given frame. In one exemplary embodiment, memory areas in external memory 120 may be configured to store pixel data in a sequential manner such that the pixel data are stored in a direction that traverses the frame-width of external memory 120.

Block data may be retrieved from external memory 120 in a similar manner. That is, pixel data may be read out of memory areas 122 of external memory 120 under the control of memory controller 140 via bus 130. In the disclosed embodiments, latency associated with bus 130 may be include latency associated with retrieval of each memory area 122 (e.g., 1 clock cycle) and bus latency, which may be any number of clock cycles. By way of example, and not limitation, the embodiments disclosed herein use a bus latency of 17 clock cycles. After the block data is retrieved from external memory 120, they may be sent to MC module 112 for motion compensation processing, including interpolation. The interpolated data may be sent to a display device (not shown). In some embodiments, the interpolated data may be stored in one or more frame memories (not shown) prior to display on a display device.

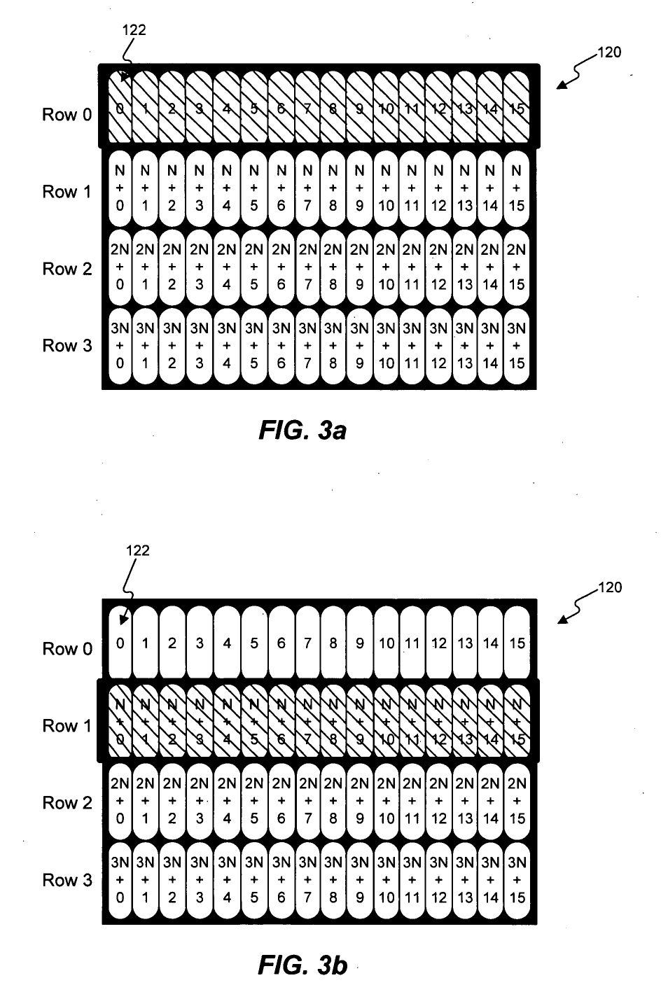

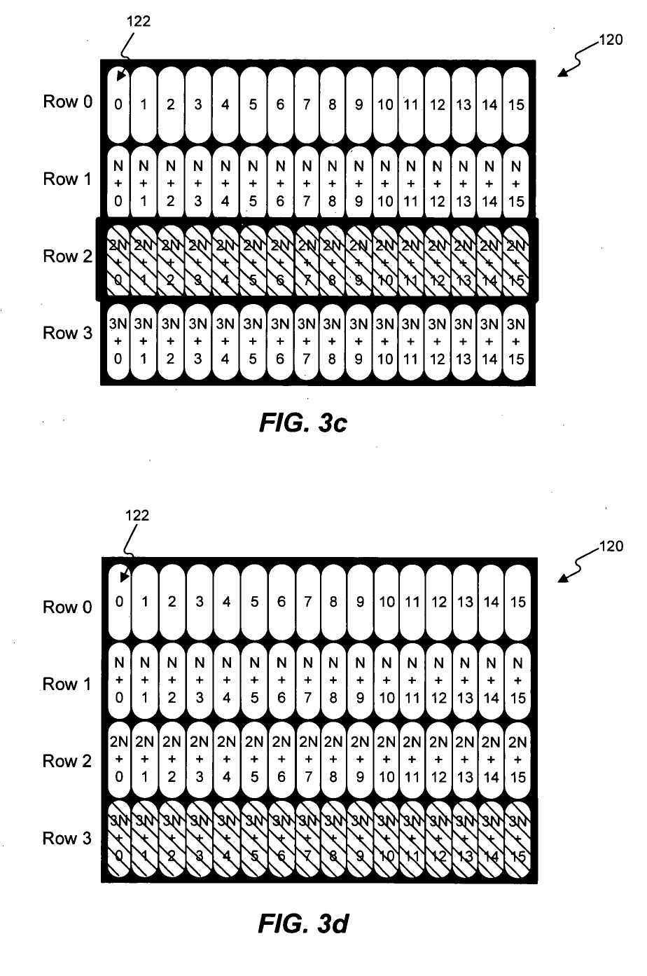

FIGS. 3a, 3b, 3c, and 3d are diagrams illustrating frame-based memory access from memory areas 122 of external memory 120 for macro block 164, consistent with certain disclosed embodiments. As discussed in connection with FIG. 2, each numbered memory area 122 (i.e., 0, 1, 2, 3, 4, 5, etc.) may include data for four pixels. As used herein, the number in each memory area 122 is used to represent the address in external memory 120 where the data for those four pixels may be located.

As shown in FIGS. 3a, 3b, 3c, and 3d, address generator 112 may sequentially reorder and store the pixel data of each 4×4 block 162 (e.g., 0, 1, 2, 3, etc.), allowing a number of memory areas 122 to be read from external memory 120 in a single continuous memory read. For example, referring to FIGS. 3a, 3b, 3c, and 3d, in turn, memory areas 122 in Row 0 (e.g., 0, 1, 2, 3, 4, 5, 6, 7, 8, 9, 10, 11, 12, 13, 14, and 15) maybe read in a first continuous memory read (FIG. 3a), memory areas 122 in Row 1 (e.g., N+0, N+1, N+2, N+3, N+4, N+5, N+6, N+7, N+8, N+9, N+10, N+11, N+12, N+13, N+14, and N+15) may be read in a second continuous memory read (FIG. 3b), memory areas 122 in Row 2 (e.g., 2N+0, 2N+1, 2N+2, 2N+3, 2N+4, 2N+5, 2N+6, 2N+7, 2N+8, 2N+9, 2N+10, 2N+11, 2N+12, 2N+13, 2N+14, and 2N+15) may be read in a third continuous memory read (FIG. 3c), and memory areas 122 in Row 3 (e.g., 3N+0, 3N+1, 3N+2, 3N+3, 3N+4, 3N+5, 3N+6, 3N+7, 3N+8, 3N+9, 3N+10, 3N+11, 3N+12, 3N+13, 3N+14, and 3N+15) may be read in a fourth continuous memory read (FIG. 3d). As a result, large amounts of sequentially ordered data may be retrieved in a single continuous memory read.

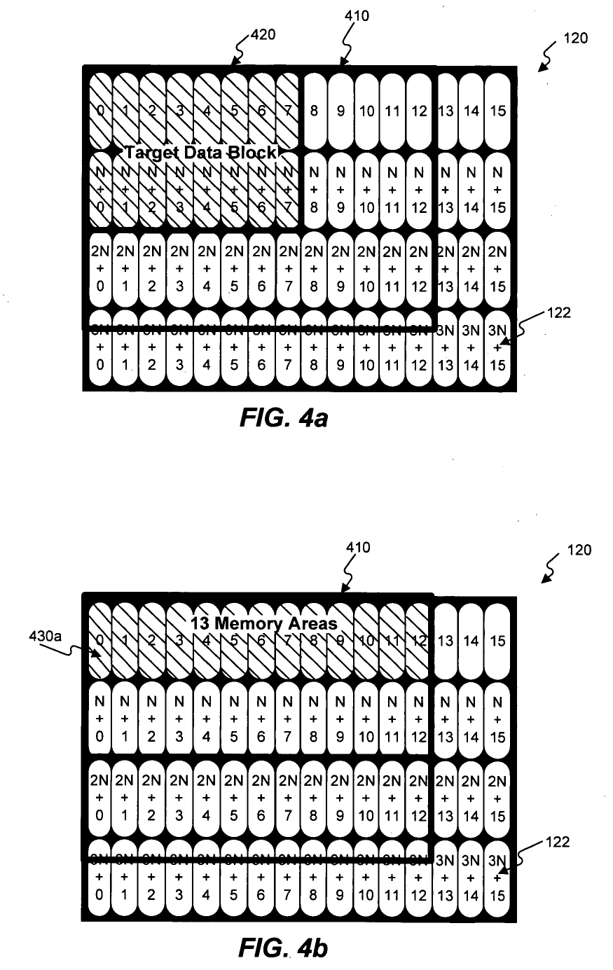

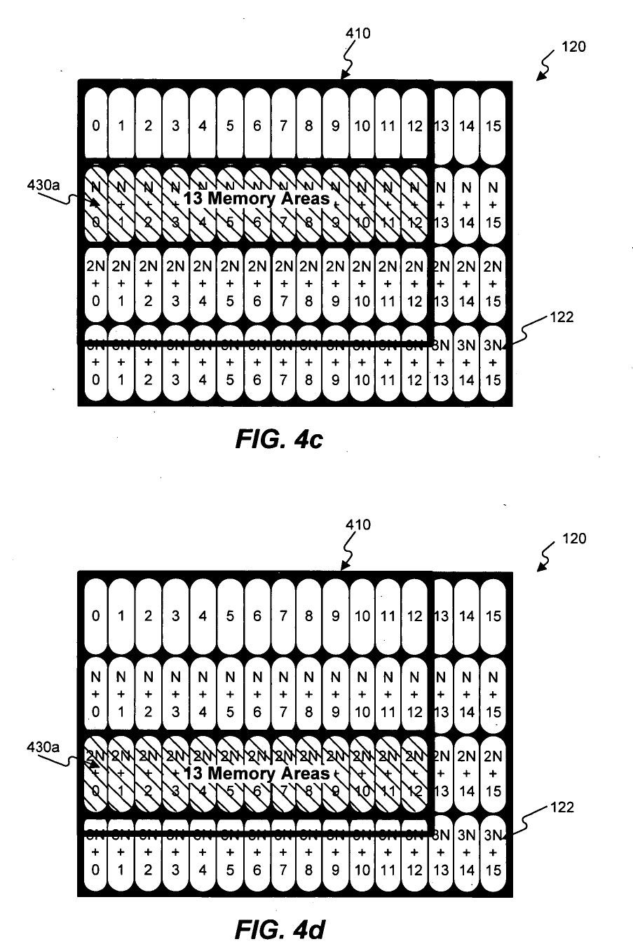

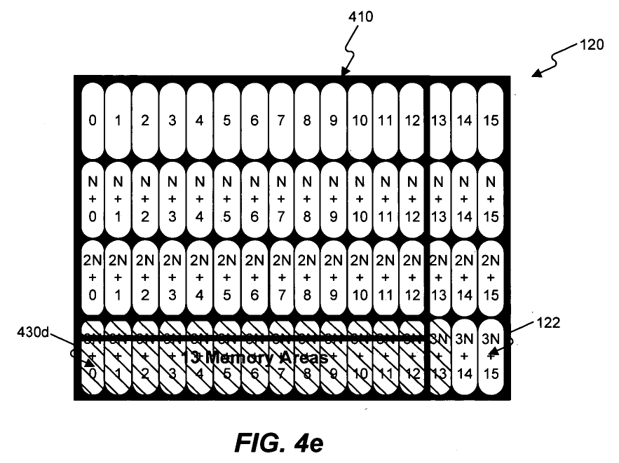

FIGS. 4a, 4b, 4c, 4d, and 4e are diagrams illustrating frame-based memory access for interpolation of 8×8 block 163. As discussed in connection with FIG. 2, each numbered memory area 122 (i.e., 0, 1, 2, 3, 4, 5, etc.) may include data for four pixels. As used herein, the number in each memory area 122 is used to represent the address in external memory 120 where the data for those four pixels may be located. As discussed previously, in order to interpolate an M×N data block, where M is the width and N is the height of current partition, an (M+5)×(N+5) reference data block is read from external memory 120. Therefore, to perform interpolation of 8×8 block 163, a 13×13 block of data is read from external memory 120. Referring, for example, to FIG. 4a, a target data block 420 illustrates memory areas 122 corresponding to the data of 8×8 block 163. A reference data block 410 illustrates memory areas 122 corresponding to the 13×13 block of data that is to be retrieved from external memory 120 for interpolation of 8×8 block 163.

Referring, in turn, to FIGS. 4b, 4c, 4d, and 4e, thirteen memory areas 122 may be read in a first continuous read 430a (FIG. 4b), thirteen memory areas 122 may be read in a second continuous read 430b (FIG. 4c), thirteen memory areas 122 may be read in a third continuous read 430c (FIG. 4d), and thirteen memory areas 122 may be read in a fourth continuous read 430d (FIG. 4e). Although shown in the order of continuous read 430a, continuous read 430b, continuous read 430c, and continuous read 430d, continuous reads 430 may be performed in any order. As shown in FIG. 4e, while only the data for one pixel in each memory area 122 of continuous read 430d is needed for reference data block 410, all the data in each memory area 122 of continuous read 430d is retrieved from external memory 120. Any pixel data retrieved from external memory 120, but not needed for interpolation, may be discarded by video decoder 110.

Table 1 is a table illustrating the total latency associated with motion compensation system 100 when obtaining pixel data from memory areas 122 associated with reference data block 410 using the memory access patterns described in FIGS. 4b, 4c, 4d, and 4e. As shown in Table 1, the latency associated with retrieving the pixel data is calculated based on the latency associated with reading each memory area 122 (i.e., 1 clock cycle), referred to as an incremental read (e.g., INCR13read, etc.), and the bus latency associated with each continuous memory read (e.g., 17 clock cycles). In the embodiment of FIGS. 4b, 4c, 4d, and 4e, fifty-two memory areas 122 are retrieved in four continuous memory reads. Thus, in one exemplary embodiment, a total latency of 120 cycles may be achieved.

TABLE 1
Latency in a Frame-Based System (8 × 8 pipeline)

| Illustrative | | |
|---|---|---|
| Figure | Description | Latency (Cycles) |
| 4b | Continuous read 430a (INCR13read + Bus | 30 |
| | Latency = 13 + 17) | |
| 4c | Continuous read 430b (INCR13read + Bus | 30 |
| | Latency = 13 + 17) | |
| 4d | Continuous read 430c (INCR13read + Bus | 30 |
| | Latency = 13 + 17) | |
| 4e | Continuous read 430d (INCR13read + Bus | 30 |
| | Latency = 13 + 17) | |
| | TOTAL LATENCY | 120 |

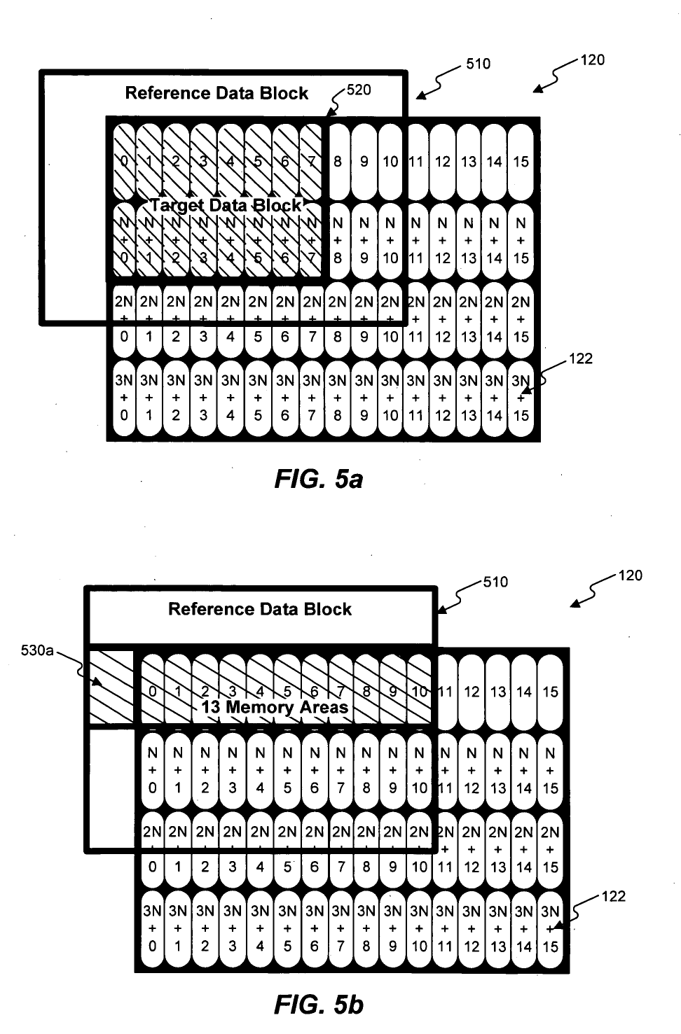

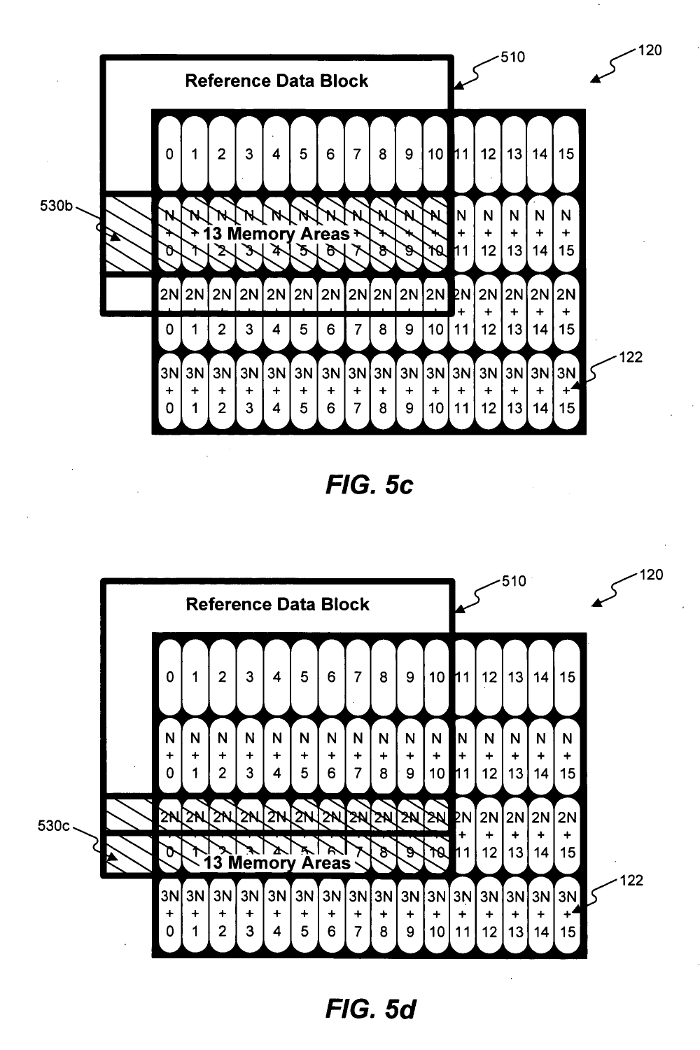

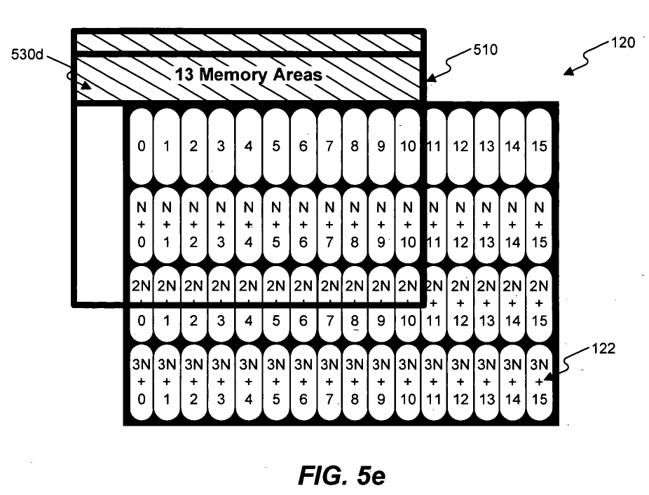

FIGS. 5a, 5b, 5c, 5d, and 5e are diagrams illustrating frame-based memory access for interpolation of 8×8 block 163. As discussed in connection with FIG. 2, each numbered memory area 122 (i.e., 0, 1, 2, 3, 4, 5, etc.) may include data for four pixels. As used herein, the number in each memory area 122 is used to represent the address in external memory 120 where the data for those four pixels may be located.

As discussed previously, to perform interpolation of 8×8 block 163, a 13×13 block of data is read from external memory 120. Referring, for example, to FIG. 5a, a target data block 520 illustrates the memory areas 122 corresponding to 8×8 block 163. A reference data block 510 illustrates the memory areas 122 corresponding to the 13×13 block of data that is to be retrieved from external memory 120 for interpolation of 8×8 block 163.

Referring, in turn, to FIGS. 5b, 5c, 5d, and 5e, thirteen memory areas 122 may be read in a first continuous read 530a (FIG. 5b), thirteen memory areas 122 may be read in a second continuous read 530b (FIG. 5c), thirteen memory areas 122 may be read in a third continuous read 530c (FIG. 5d), and thirteen memory areas 122 may be read in a fourth continuous read 530d (FIG. 5e). Although shown in the order of continuous read 530a, continuous read 530b, continuous read 530c, and continuous read 530d, continuous reads 530 may be performed in any order. As shown in FIG. 5e, while only the data for one pixel in each memory area 122 of fourth continuous read 530d is needed for reference data block 510, all the pixel data in each memory area 122 of fourth continuous read 530d is retrieved from external memory 120. Any pixel data retrieved from external memory 120, but not needed for interpolation, may be discarded by video decoder 110.

Table 2 is a table illustrating the total latency associated with motion compensation system 100 when obtaining pixel data from memory areas 122 associated with reference data block 510 using the memory access patterns described in FIGS. 5b, 5c, 5d, and 5. As shown in Table 2, the latency associated with retrieving the pixel data is calculated based on the latency associated with reading each memory area 122 (i.e., 1 clock cycle), referred to as an incremental read (e.g., INCR13read, etc.), and the bus latency associated with each continuous memory read (e.g., 17 clock cycles). In the embodiment of FIGS. 5b, 5c, 5d, and 5e, fifty-two memory areas 122 are read in four continuous memory reads. Thus, in one exemplary embodiment, a total latency of 120 cycles may be achieved.

TABLE 2
Latency in a Frame-Based System (8 × 8 pipeline)

| Illustrative | | |
|---|---|---|
| Figure | Description | Latency (Cycles) |
| 5b | Continuous read 530a (INCR13read + Bus | 30 |
| | Latency = 13 + 17) | |
| 5c | Continuous read 530b (INCR13read + Bus | 30 |
| | Latency = 13 + 17) | |
| 5d | Continuous read 530c (INCR13read + Bus | 30 |
| | Latency = 13 + 17) | |
| 5e | Continuous read 530d (INCR13read + Bus | 30 |
| | Latency = 13 + 17) | |
| | TOTAL LATENCY | 120 |

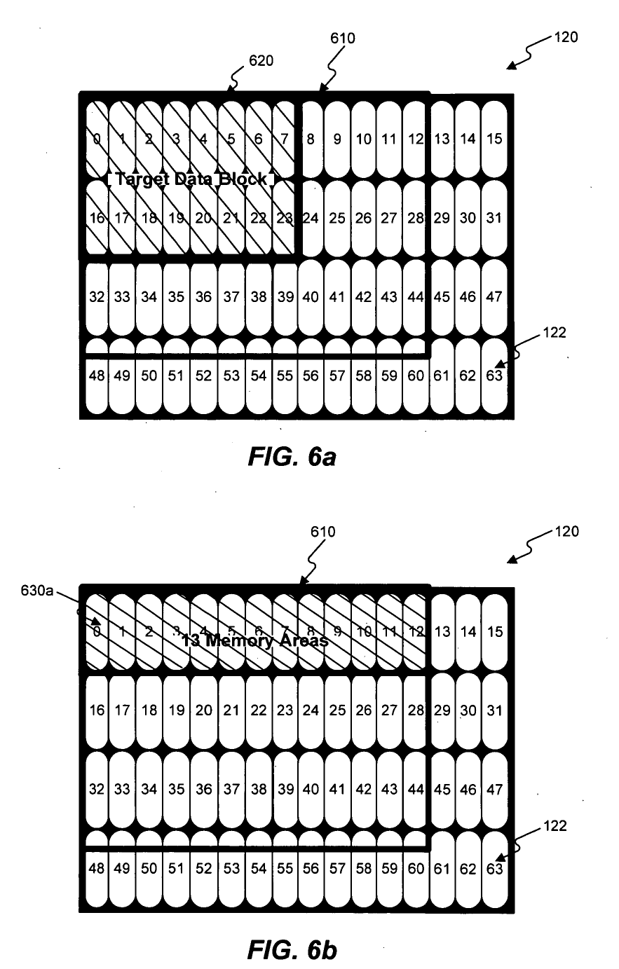

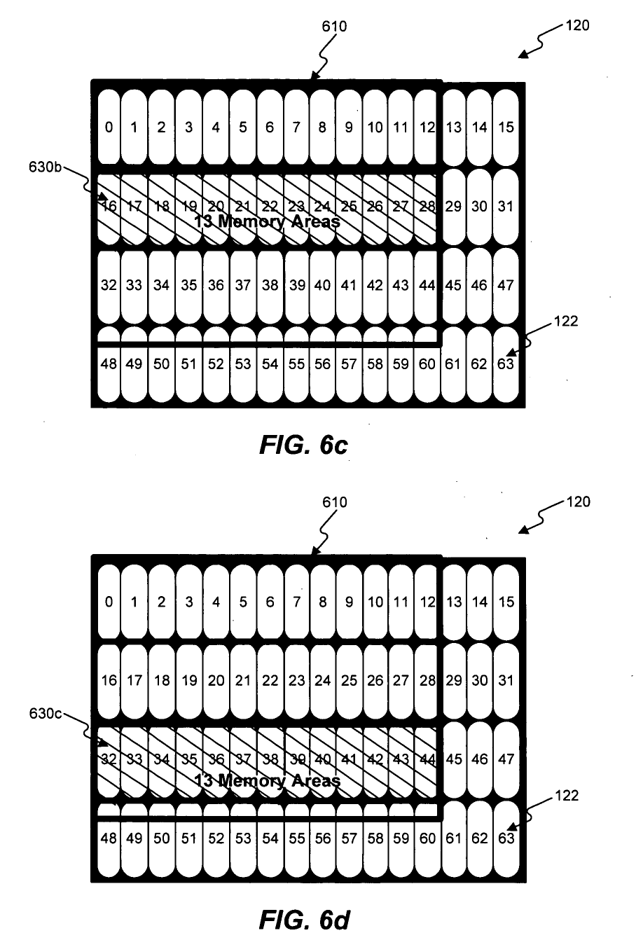

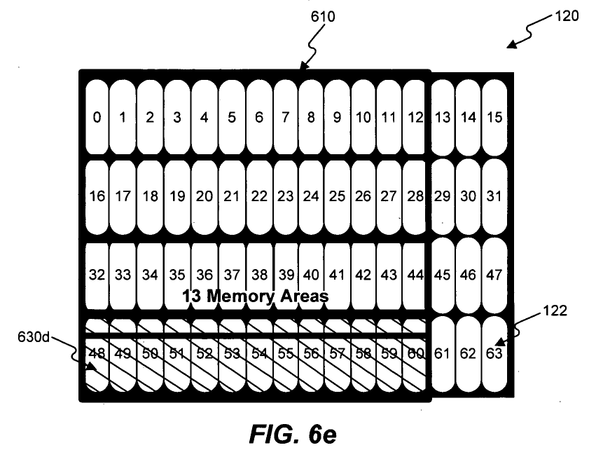

FIGS. 6a, 6b, 6c, 6d, and 6e are diagrams illustrating block-based memory access for interpolation of 8×8 block 163. As discussed in connection with FIG. 2, each numbered memory area 122 (i.e., 0, 1, 2, 3, 4, 5, etc.) may include data for four pixels. As used herein, the number in each memory area 122 is used to represent the address in external memory 120 where the data for those four pixels may be located.

As discussed previously, to perform interpolation of 8×8 block 163, a 13×13 block of data is read from external memory 120. Referring, for example, to FIG. 6a, a target data block 620 illustrates the memory area 122 corresponding to 8×8 block 163. A reference data block 610 illustrates the memory area 122 corresponding to the 13×13 block of data that is to be retrieved from external memory 120 for interpolation of 8×8 block 163.

Referring, in turn, to FIGS. 6b, 6c, 6d, and 6e, thirteen memory areas 122 (i.e., 0 to 12) may be read in a first continuous read 630a (FIG. 6b), thirteen memory areas 122 may be read in a second continuous read 630b (FIG. 6c), thirteen memory areas 122 may be read in a third continuous read 630c (FIG. 6d), and thirteen memory areas 122 may be read in a fourth continuous read 630d (FIG. 6e). As shown in FIG. 6e, while only the data for one pixel in each memory area 122 of fourth continuous read 630d is needed for reference data block 610, all the pixel data for each memory area 122 of fourth continuous read 630d is retrieved from external memory 120. Any pixel data retrieved from external memory 120, but not needed for interpolation, may be discarded by video decoder 110.

Table 3 is a table illustrating the total latency associated with motion compensation system 100 when obtaining pixel data from memory areas 122 associated with reference data block 610 using the memory access patterns described in FIGS. 6b, 6c, 6d, and 6e. As shown in Table 3, the latency associated with reading the pixel data is calculated based on the latency associated with reading each memory area 122 (i.e., 1 clock cycle), referred to as an incremental read (e.g., INCR13read, etc.), and the bus latency associated with each continuous memory read (e.g., 17 clock cycles). In the embodiment of FIGS. 6b, 6c, 6d, and 6e, forty-four memory areas 122 are read in four continuous memory reads. Thus, in one exemplary embodiment, a total latency of 120 cycles may be achieved.

TABLE 3
Latency in a Macro Block-Based System (8 × 8 pipeline)

| Illustrative | | |
|---|---|---|
| Figure | Description | Latency (Cycles) |
| 6b | Continuous read 630a (INCR13read + Bus | 30 |
| | Latency = 13 + 17) | |
| 6c | Continuous read 630b (INCR13read + Bus | 30 |
| | Latency = 13 + 17) | |
| 6d | Continuous read 630c (INCR13read + Bus | 30 |
| | Latency = 13 + 17) | |
| 6e | Continuous read 630d (INCR13read + Bus | 30 |
| | Latency = 13 + 17) | |
| | TOTAL LATENCY | 120 |

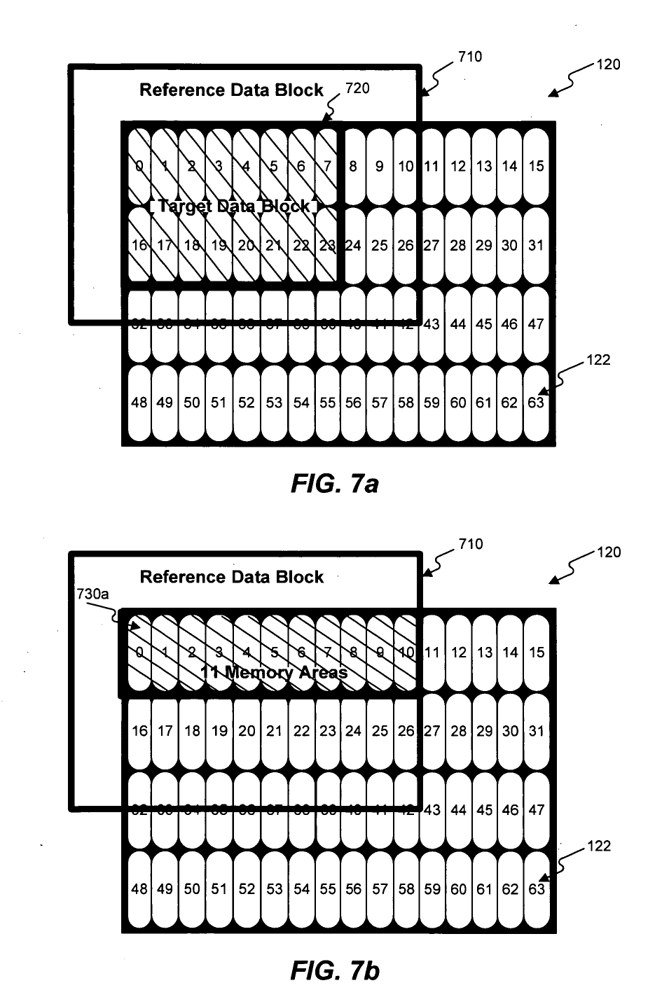

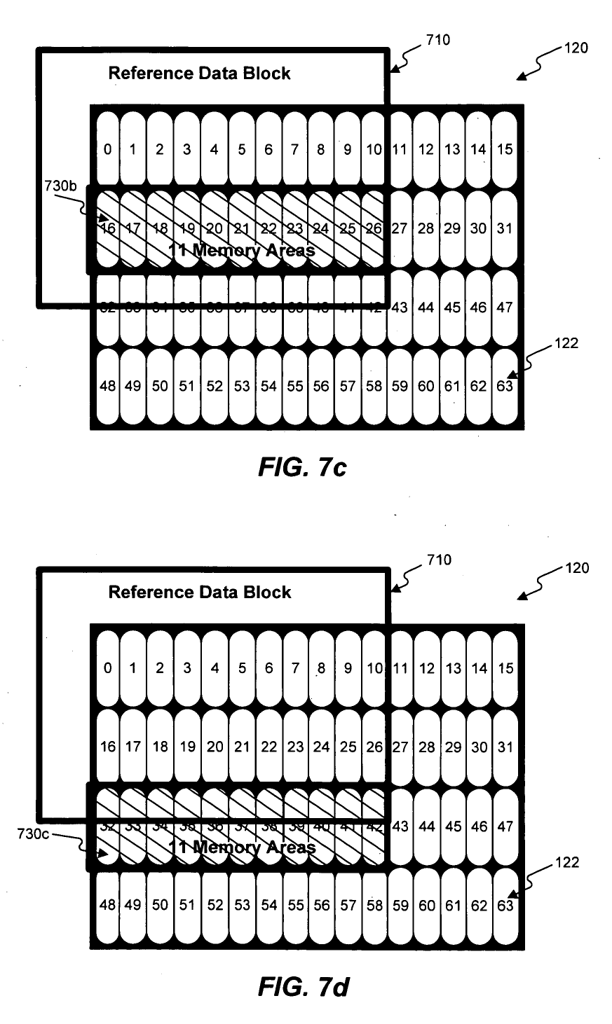

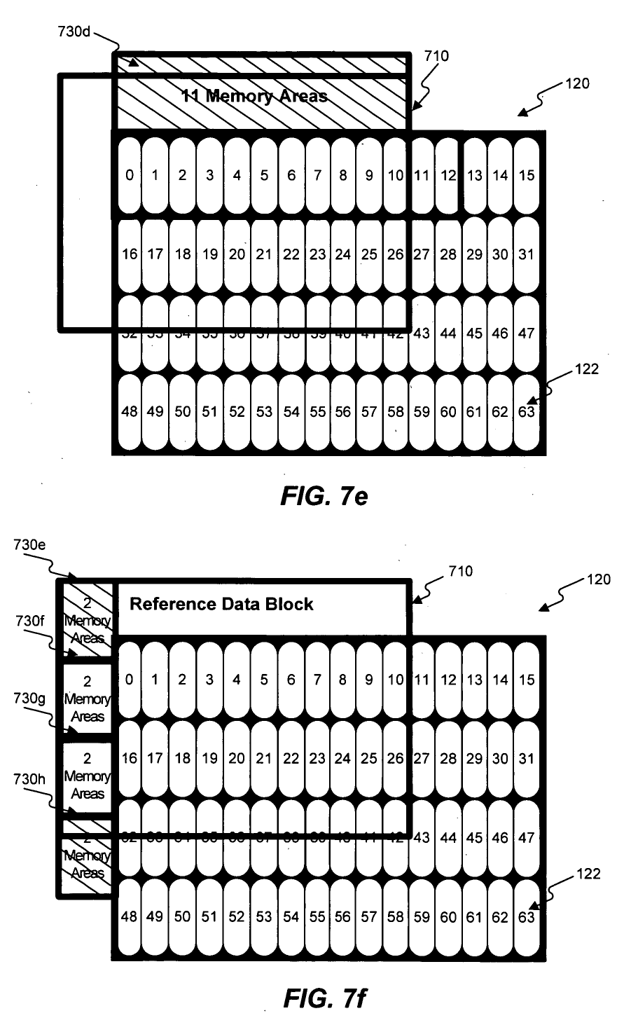

FIGS. 7a, 7b, 7c, 7d, 7e, and 7f are diagrams illustrating macro block-based memory access for interpolation of 8×8 block 163. As discussed in connection with FIG. 2, each numbered memory area 122 (i.e., 0, 1, 2, 3, 4, 5, etc.) may include data for four pixels. As used herein, the number in each memory area 122 is used to represent the address in external memory 120 where the data for those four pixels may be located.

As discussed previously, to perform interpolation of 8×8 block 163, a 13×13 block of data is read from external memory 120. Referring, for example, to FIG. 7a, a target data block 720 illustrates the memory areas 122 corresponding to 8×8 block 163. A reference data block 710 illustrates the memory areas 122 corresponding to the 13×13 block of data that is to be retrieved from external memory 120 for interpolation of 8×8 block 163.

Referring, in turn, to FIGS. 7b, 7c, 7d, 7e, and 7f, eleven memory areas 122 may be read in a first continuous read 730a (FIG. 7b), eleven memory areas 122 may be read in a second continuous read 730b (FIG. 7c), eleven memory areas 122 may be read in a third continuous read 730c (FIG. 7d), eleven memory areas 122 may be read in a fourth continuous read 730d (FIG. 7e), two memory areas 122 may be read in a fifth continuous read 730e (FIG. 7f), two memory areas 122 may be read in a sixth continuous read 730f (FIG. 7f), two memory areas 122 may be read in a seventh continuous read 730g (FIG. 7f), and two memory areas 122 may be read in a eighth continuous read 730h (FIG. 7f). As shown in FIGS. 7d, 7e, and 7f, only a portion of the pixel in some of the memory areas 122 read during fifth continuous read 730e, sixth continuous read 730f, seventh continuous read 730g, and eighth continuous read 730h is needed for reference data block 710, however, all the pixel data for each memory area 122 is retrieved from external memory 120. Any pixel data retrieved from external memory 120, but not needed for interpolation, may be discarded by video decoder 110.

Table 4 is a table illustrating the total latency associated with motion compensation system 100 when obtaining pixel data from memory areas 122 associated with reference data block 710 using the memory access patterns described in FIGS. 7b, 7c, 7d, 7e, and 7f. As shown in Table 4, the latency associated with retrieving the pixel data is calculated based on the latency associated with reading each memory area 122 (i.e., 1 clock cycle), referred to as an incremental read (e.g., INCR11read, INCR2read, etc.), and the bus latency associated with each continuous memory read (e.g., 17 clock cycles). In the embodiment of FIGS. 7b, 7c, 7d, 7e, and 7f, fifty-two memory areas 122 are read in eight continuous memory reads. Thus, in one exemplary embodiment, a total latency of 188 cycles may be achieved.

TABLE 4
Latency in a Macro Block-Based System (8 × 8 pipeline)

| Illustrative | | |
|---|---|---|
| Figure | Description | Latency (Cycles) |
| 7b | Continuous read 730a (INCR11read + Bus | 28 |
| | Latency = 11 + 17) | |
| 7c | Continuous read 730b (INCR11read + Bus | 28 |
| | Latency = 11 + 17) | |
| 7d | Continuous read 730c (INCR11read + Bus | 28 |
| | Latency = 11 + 17) | |
| 7e | Continuous read 730d (INCR11read + Bus | 28 |
| | Latency = 11 + 17) | |
| 7f | Continuous read 730e (INCR2read + Bus | 19 |
| | Latency = 2 + 17) | |
| 7f | Continuous read 730f (INCR2read + Bus | 19 |
| | Latency = 2 + 17) | |
| 7f | Continuous read 730g (INCR2read + Bus | 19 |
| | Latency = 2 + 17) | |
| 7f | Continuous read 730h (INCR2read + Bus | 19 |
| | Latency = 2 + 17) | |
| | TOTAL LATENCY | 188 |

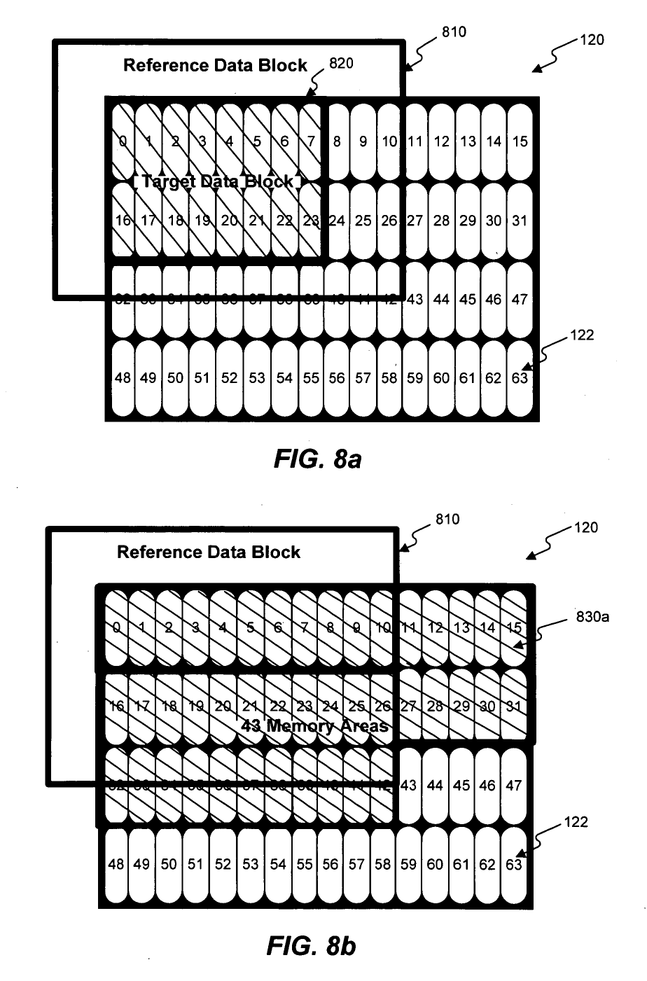

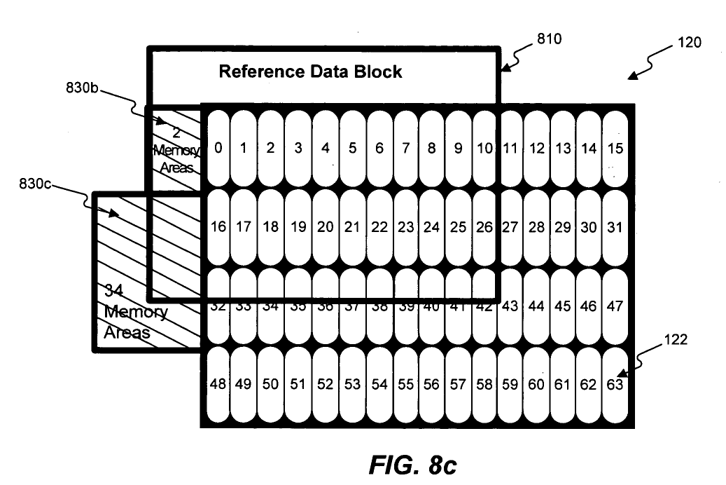

FIGS. 8a, 8b, and 8c are diagrams illustrating macro block-based memory access for interpolation of 8×8 block 163. As discussed in connection with FIG. 2, each numbered memory area 122 (i.e., 0, 1, 2, 3, 4, 5, etc.) may include data for four pixels. As used herein, the number in each memory area 122 is used to represent the address in external memory 120 where the data for those four pixels may be located.

As discussed previously, to perform interpolation of 8×8 block 163, a 13×13 block of data is read from external memory 120. Referring, for example, to FIG. 8a, a target data block 820 illustrates the memory areas 122 corresponding to 8×8 block 163. A reference data block 810 illustrates the memory areas 122 corresponding to the 13×13 block of data that is to be retrieved from external memory 120 for interpolation of 8×8 block 163.

Referring, in turn, to FIGS. 8b and 8c, forty-three memory areas 122 (i.e., 0 to 42) may be read in a first continuous read 830a (FIG. 8b), followed by two memory areas 122 read in a second continuous read 830b (FIG. 8c), and thirty-four memory areas 122 read in a third continuous read 830c (FIG. 8c). As shown in FIG. 8c, only a portion of the pixel data in the thirty-four memory areas 122 of third continuous read 830c is needed for reference data block 810, however, all the pixel data in the thirty-four memory areas 122 of third continuous read 830c are read from external memory 120. Any pixel data read from external memory 120, but not needed for interpolation, may be discarded by video decoder 110.

Table 5 is a table illustrating the total latency associated with motion compensation system 100 when obtaining pixel data from memory areas 122 associated with reference data block 810 using the memory access patterns described in FIGS. 8b and 8c. As shown in Table 5, the latency associated with reading the pixel data is calculated based on the latency associated with reading each memory area 122 (i.e., 1 clock cycle), referred to as an incremental read (e.g., INCR43read, INCR2read, INCR34read, etc.), and the bus latency associated with each continuous memory read (e.g., 17 clock cycles). In the embodiment of FIGS. 8b and 8c, seventy-nine memory areas 122 are read in three continuous memory reads. Thus, in one exemplary embodiment, a total latency of 177 cycles may be achieved.

TABLE 5
Latency in a Macro Block-Based System (8 × 8 pipeline)

| Illustrative | | |
|---|---|---|
| Figure | Description | Latency (Cycles) |
| 8b | Continuous read 830a (INCR43read + Bus | 60 |
| | Latency = 43 + 17) | |
| 8c | Continuous read 830b (INCR2read + Bus | 19 |
| | Latency = 2 + 17) | |
| 8c | Continuous read 830c (INCR34read + Bus | 51 |
| | Latency = 34 + 17) | |
| | TOTAL LATENCY | 177 |

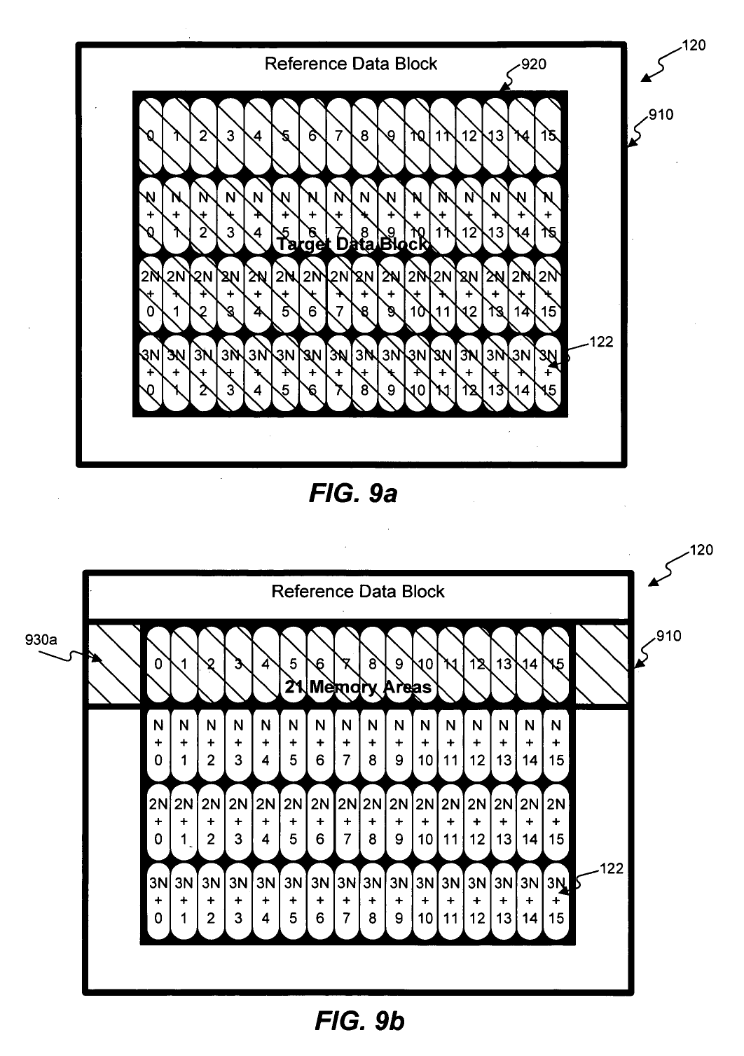

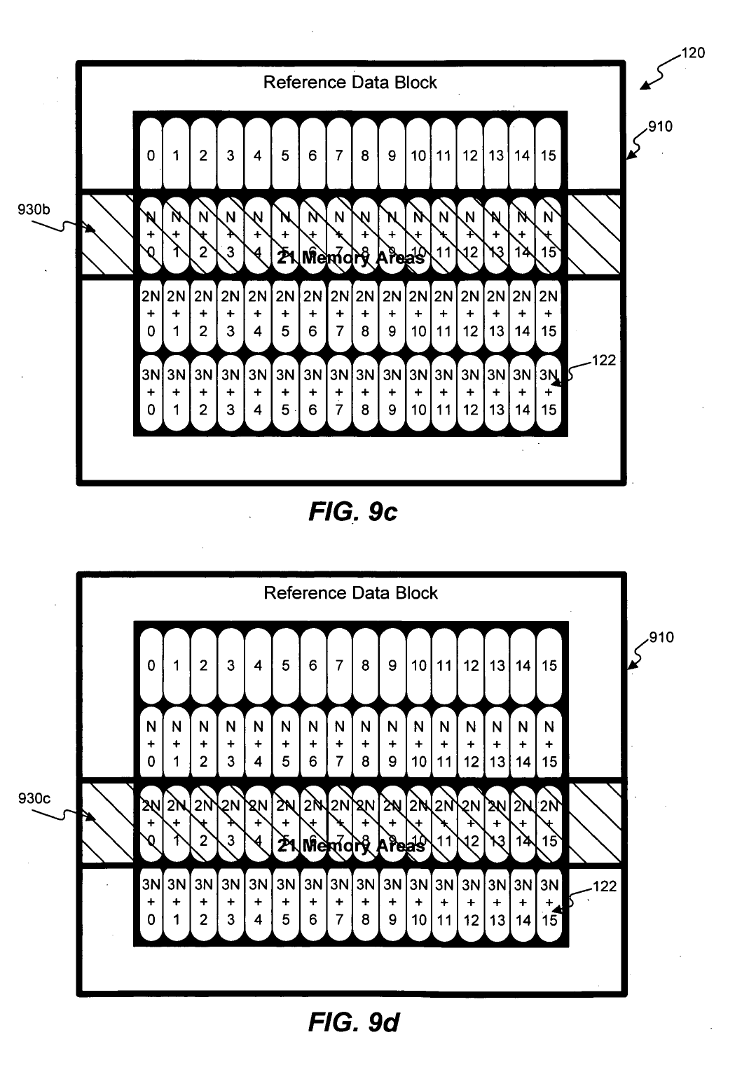

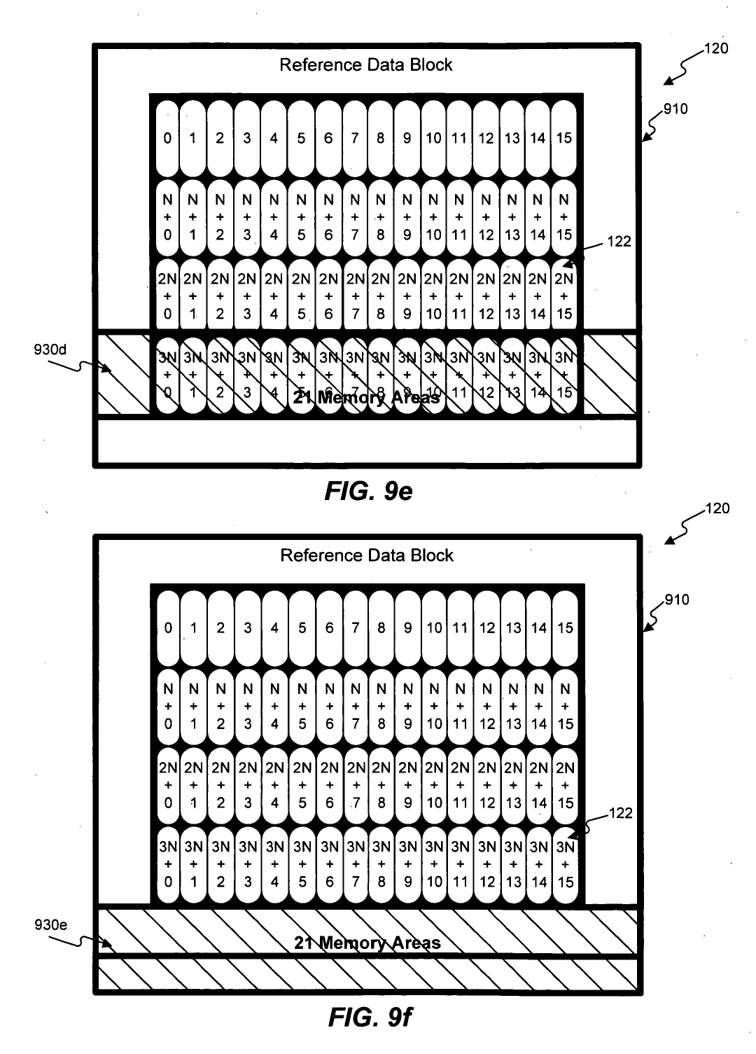

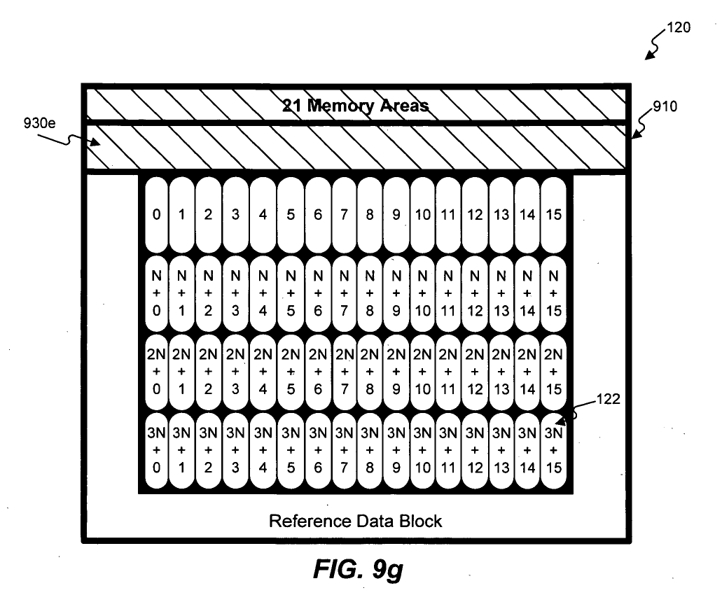

FIGS. 9a, 9b, 9c, 9d, 9e, 9f, and 9g are diagrams illustrating frame-based memory access for interpolation of 16×16 macro block 164. As discussed in connection with FIG. 2, each numbered memory area 122 (i.e., 0, 1, 2, 3, 4, 5, etc.) may include data for four pixels. As used herein, the number in each memory area 122 is used to represent the address in external memory 120 where the data for those four pixels may be located.

As discussed previously, to perform interpolation of 16×16 macro block 164, a 21×21 block of data is read from external memory 120. Referring, for example, to FIG. 9a, a target data block 920 illustrates the memory areas 122 corresponding to 16×16 macro block 164. A reference data block 910 illustrates the memory areas 122 corresponding to the 21×21 block of reference data that is to be retrieved from external memory 120 for interpolation of 16×16 macro block 164.

Referring, in turn, to FIGS. 9b, 9c, 9d, 9e, 9f, and 9g, twenty-one memory areas 122 may be read in a first continuous read 930a (FIG. 9b), twenty-one memory areas 122 may be read in a second continuous read 930b (FIG. 9c), twenty-one memory areas 122 may be read in a third continuous read 930c (FIG. 9d), twenty-one memory areas 122 may be read in a fourth continuous read 930d (FIG. 9e), twenty-one memory areas 122 may be read in a fifth continuous read 930e (FIG. 9f), and twenty-one memory areas 122 may be read in a sixth continuous memory access 930f (FIG. 9g). As shown in FIGS. 9f and 9g, only a portion of the pixel data read in fifth continuous memory access 930e and sixth continuous read 930f is needed for reference data block 910, however, all the pixel data in each of the twenty-one memory areas 122 in the fifth continuous read 930e and the twenty-one memory areas 122 in the sixth continuous read 930f are read from external memory 120. Any pixel data read from external memory 120, but not needed for interpolation, may be discarded by video decoder 110.

Table 6 is a table illustrating the total latency associated with motion compensation system 100 when obtaining pixel data from memory areas 122 associated with reference data block 910 using the memory access patterns described in FIGS. 9b, 9c, 9d, 9e, 9f, and 9g. As shown in Table 6, the latency associated with reading the pixel data is calculated based on the latency associated with reading each memory area 122 (i.e., 1 clock cycle), referred to as an incremental read (e.g., INCR21read, etc.), and the bus latency associated with each continuous memory read (e.g., 17 clock cycles). In the embodiment of FIGS. 9b, 9c, 9d, 9e, 9f, and 9g, ninety-six memory areas 122 are read in six continuous memory reads. Thus, in one exemplary embodiment, a total latency of 228 cycles may be achieved.

TABLE 6
Latency in a Frame-Based System (16 × 16 pipeline)

| Illustrative | | |
|---|---|---|
| Figure | Description | Latency (Cycles) |
| 9b | Continuous read 930a (INCR21read + Bus | 38 |
| | Latency = 21 + 17) | |
| 9c | Continuous read 930b (INCR21read + Bus | 38 |
| | Latency = 21 + 17) | |
| 9d | Continuous read 930c (INCR21read + Bus | 38 |
| | Latency = 21 + 17) | |
| 9e | Continuous read 930d (INCR21read + Bus | 38 |
| | Latency = 21 + 17) | |
| 9f | Continuous read 930e (INCR21read + Bus | 38 |
| | Latency = 21 + 17) | |
| 9g | Continuous read 930f (INCR21read + Bus | 38 |
| | Latency = 21 + 17) | |
| | TOTAL LATENCY | 228 |

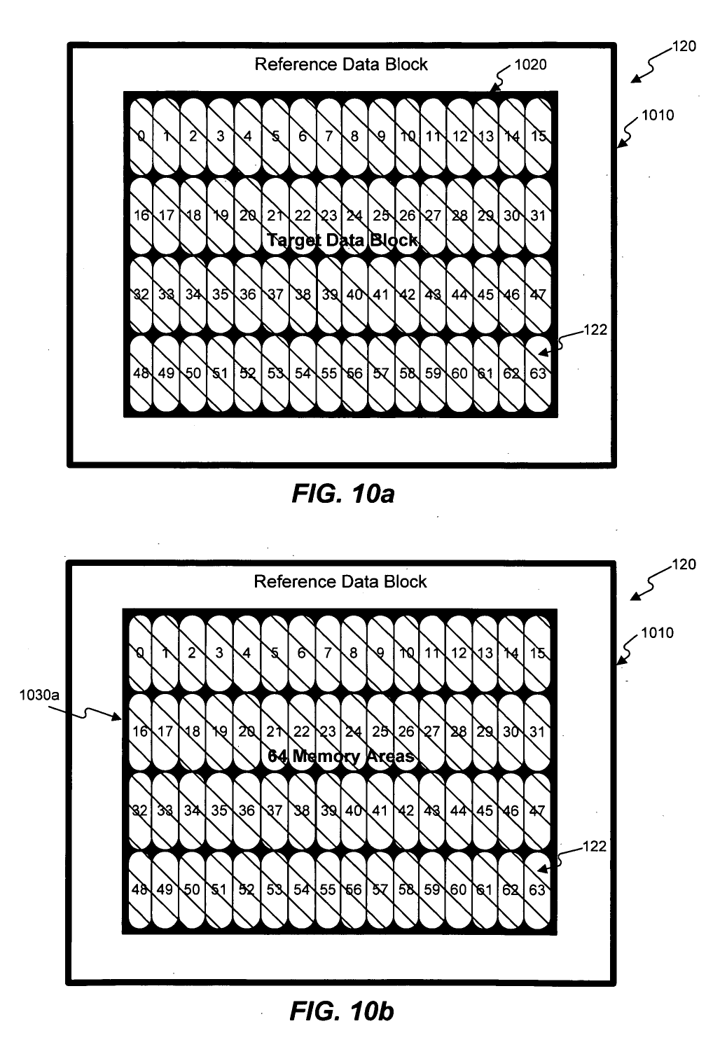

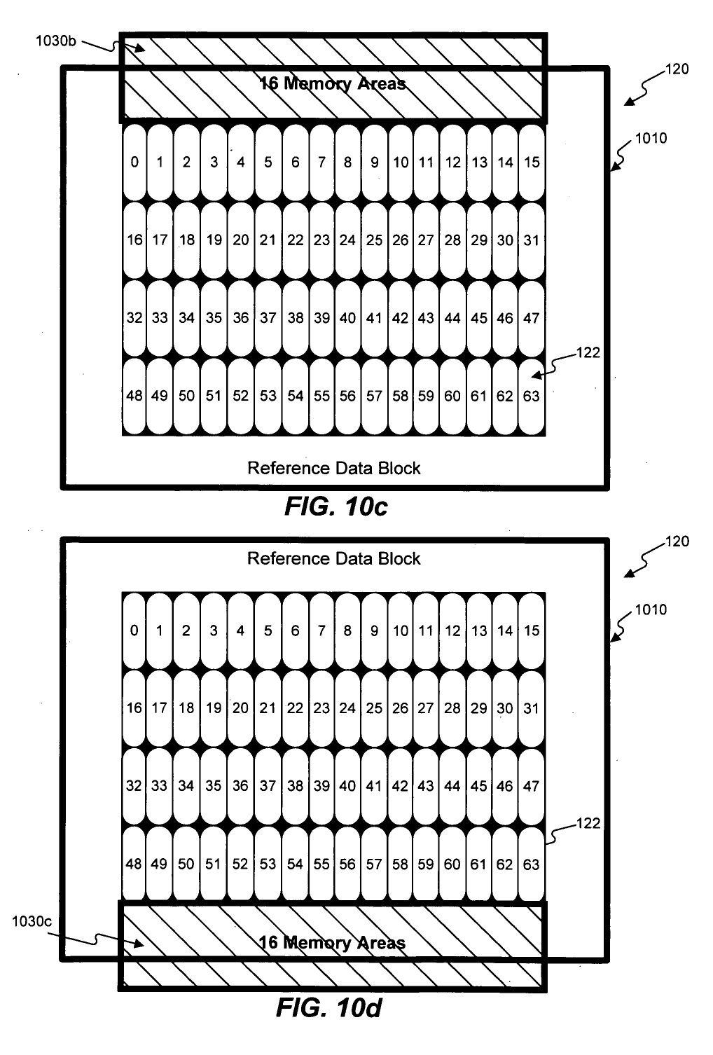

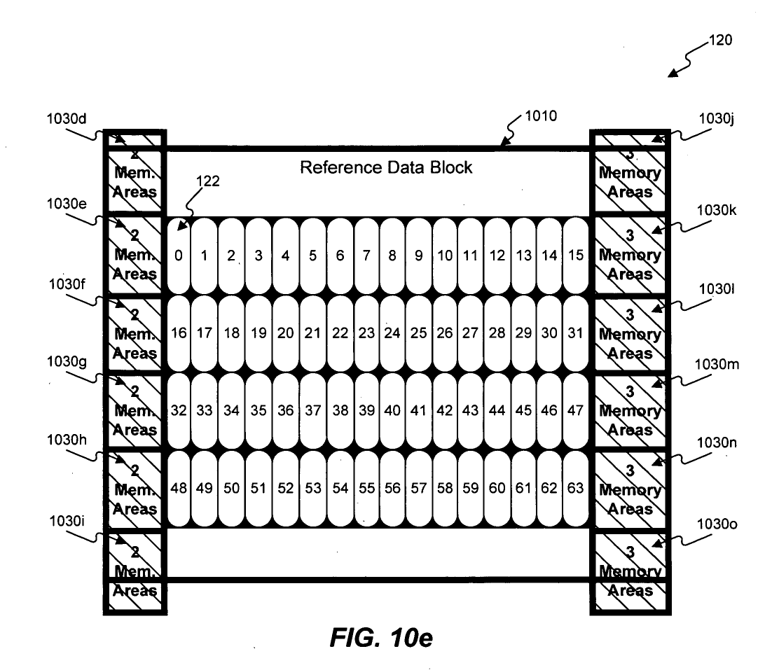

FIGS. 10a, 10b, 10c, 10d, and 10e are diagrams illustrating macro block-based memory access for interpolation of 16×16 macro block 164. As discussed in connection with FIG. 2, each numbered memory area 122 (i.e., 0, 1, 2, 3, 4, 5, etc.) may include data for four pixels. As used herein, the number in each memory area 122 is used to represent the address in external memory 120 where the data for those four pixels may be located.

As discussed previously, to perform interpolation of 16×16 macro block 164, a 21×21 block of data is read from external memory 120. Referring, for example, to FIG. 10a, a target data block 1020 illustrates the memory areas 122 corresponding to 16×16 macro block 164. A reference data block 1010 illustrates the memory areas 122 corresponding to the 21×21 block of reference data that is to be retrieved from external memory 120 for interpolation of 16×16 macro block 164.

Referring, in turn, to FIGS. 10b, 10c, 10d, and 10e, sixty-four memory areas 122 may be read in a first continuous read 1030a (FIG. 10b), sixteen memory areas 122 may be read in a second continuous read 1030b (FIG. 10c), sixteen blocks 122 may be read in a third continuous read 1030c (FIG. 10d), two memory areas 122 may be read in a fourth continuous read 1030d (FIG. 10e), two memory areas 122 may be read in a fifth continuous read 1030e (FIG. 10e) two memory areas 122 may be read in a sixth continuous read 1030f (FIG. 10e), two memory areas 122 may be read in a seventh continuous read 1030g (FIG. 10e), two memory areas 122 may be read in a eighth continuous read 1030h (FIG. 10e), two memory areas 122 may be read in a ninth continuous read 1030i (FIG. 10e), three memory areas 122 may be read in a tenth continuous read 1030j (FIG. 10e), three memory areas 122 may be read in an eleventh continuous read 1030k (FIG. 10e), three memory areas 122 may be read in a twelfth continuous read 1030l (FIG. 10e), three memory areas 122 may be read in a thirteenth continuous read 1030m (FIG. 10e), three memory areas 122 may be read in a fourteenth continuous read 1030n (FIG. 10e), and three memory areas 122 may be read in a fifteenth continuous read 1030o (FIG. 10e). As shown in FIGS. 10b, 10c, 10d, and 10e, only a portion of the pixel data in fourth continuous read 1030d, ninth continuous read 1030i, tenth continuous read 1030j, and fifteenth continuous read 1030o is needed for reference data block 1010, however, all the data for each memory area 122 of the continuous reads 1030d, 1030i, 1030j, and 1030o are read from external memory 120. Any pixel data read from external memory 120, but not needed for interpolation, may be discarded by video decoder 110.

Table 7 is a table illustrating the total latency associated with motion compensation system 100 when obtaining pixel data in memory areas 122 associated with reference data block 1010 using the memory access patterns described in FIGS. 10b, 10c, 10d, and 10e. As shown in Table 7, the latency associated with retrieving the pixel data is calculated based on the latency associated with reading each memory area 122 (i.e., 1 clock cycle), referred to as an incremental read (e.g., INCR64read, INCR16read, INCR2read, INCR3read, etc.), and the bus latency associated with each continuous memory read (e.g., 17 clock cycles). In the embodiment of FIGS. 10b, 10c, 10d, and 10e, one hundred and twenty-six memory areas 122 are read in fifteen continuous memory reads. Thus, in one exemplary embodiment, a total latency of 381 cycles may be achieved.

TABLE 7
Latency in a Macro Block-Based System (16 × 16 pipeline)

| Illustrative | | Latency |
|---|---|---|
| Figure | Description | (Cycles) |
| 10b | Continuous read 1030a (INCR64read + Bus | 81 |
| | Latency = 64 + 17) | |
| 10c | Continuous read 1030b (INCR16read + Bus | 33 |
| | Latency = 16 + 17) | |
| 10d | Continuous read 1030c (INCR16read + Bus | 33 |
| | Latency = 16 + 17) | |
| 10e | Continuous read 1030d (INCR2read + Bus | 19 |
| | Latency = 2 + 17) | |
| 10e | Continuous read 1030e (INCR2read + Bus | 19 |
| | Latency = 2 + 17) | |
| 10e | Continuous read 1030f (INCR2read + Bus | 19 |
| | Latency = 2 + 17) | |
| 10e | Continuous read 1030g (INCR2read + Bus | 19 |
| | Latency = 2 + 17) | |
| 10e | Continuous read 1030h (INCR2read + Bus | 19 |
| | Latency = 2 + 17) | |
| 10e | Continuous read 1030i (INCR2read + Bus | 19 |
| | Latency = 2 + 17) | |
| 10e | Continuous read 1030j (INCR3read + Bus | 20 |
| | Latency = 3 + 17) | |
| 10e | Continuous read 1030k (INCR3read + Bus | 20 |
| | Latency = 3 + 17) | |
| 10e | Continuous read 1030l (INCR3read + Bus | 20 |
| | Latency = 3 + 17) | |
| 10e | Continuous read 1030m (INCR3read + Bus | 20 |
| | Latency = 3 + 17) | |
| 10e | Continuous read 1030n (INCR3read + Bus | 20 |
| | Latency = 3 + 17) | |
| 10e | Continuous read 1030o (INCR3read + Bus | 20 |
| | Latency = 3 + 17) | |
| | TOTAL LATENCY | 381 |

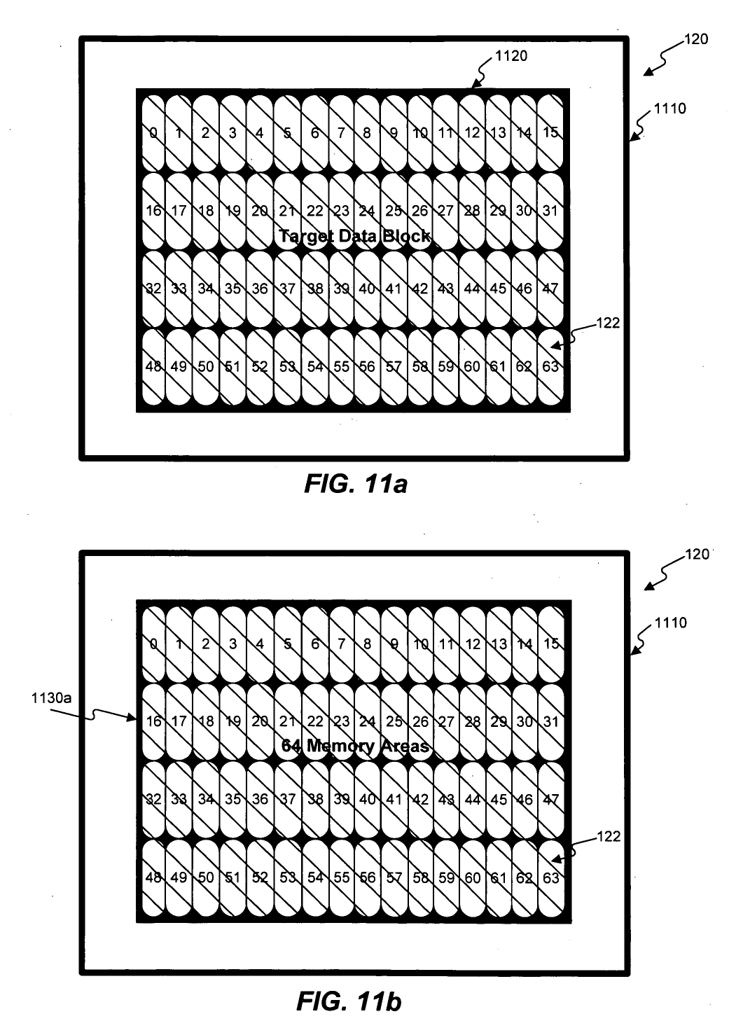

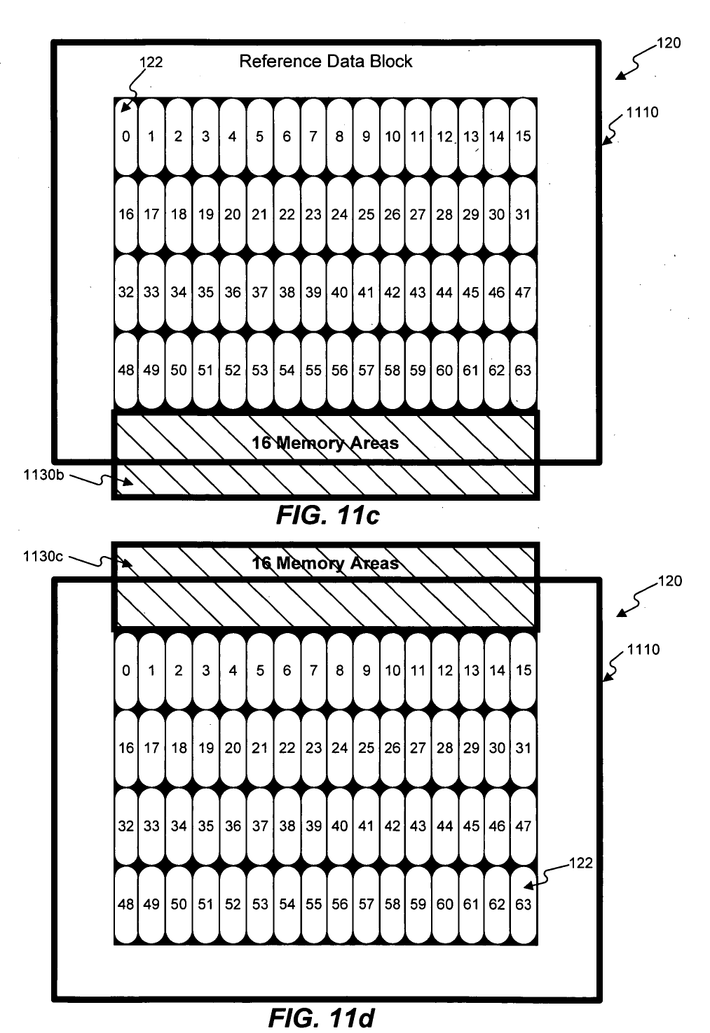

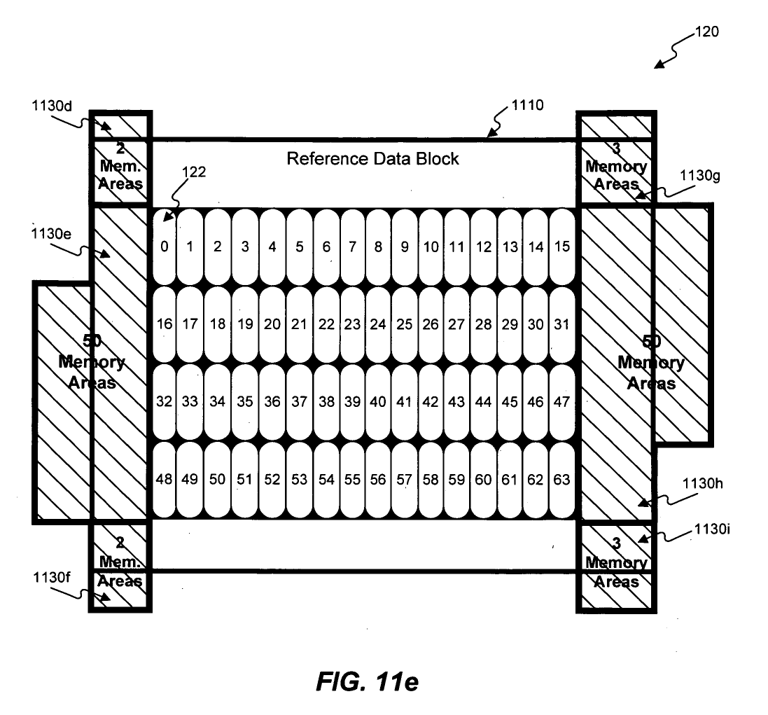

FIGS. 11a, 11b, 11c, 11d, and 11e are diagrams illustrating macro block-based memory access for interpolation of 16×16 macro block 164. As discussed in connection with FIG. 2, each numbered memory area 122 (i.e., 0, 1, 2, 3, 4, 5, etc.) may include data for four pixels. As used herein, the number in each memory area 122 is used to represent the address in external memory 120 where the data for those four pixels may be located.

As discussed previously, to perform interpolation of 16×16 macro block 164, a 21×21 block of data is read from external memory 120. Referring, for example, to FIG. 11a, a target data block 1120 illustrates the memory areas 122 corresponding to 16×16 macro block 164. A reference data block 1110 illustrates the memory areas 122 corresponding to the 21×21 block of reference data that is to be retrieved from external memory 120 for interpolation of 16×16 macro block 164.

Referring, in turn, to FIGS. 11b, 11c, 11d, and 11e, sixty-four memory areas 122 may be read in a first continuous read 1130a (FIG. 11b), sixteen memory areas 122 may be read in a second continuous read 1130b (FIG. 11c), sixteen memory areas 122 may be read in a third continuous read 1130c (FIG. 11d), two memory areas 122 may be read in a fourth continuous read 1030d (FIG. 11e), fifty memory areas 122 may be read in a fifth continuous read 1130e (FIG. 11e), two memory areas 122 may be read in a sixth continuous read 1030f (FIG. 11e), three memory areas 122 may be read in a seventh continuous read 1130g (FIG. 11e), fifty memory areas 122 may be read in an eighth continuous read 1130h (FIG. 11e), and three memory areas 122 may be read in a ninth continuous read 1130i (FIG. 11e). As shown in FIGS. 11b, 11c, 11d, and 11e, only a portion of the pixel data in fourth continuous access 1030d, sixth continuous read 1130e, seventh continuous read 1130f, and ninth continuous read 1130i is needed for reference data block 1110, however, all the pixel data in each memory area 122 of the continuous reads 1130d, 1130e, 1130f, and 1130i is retrieved from external memory 120. Any pixel data read from external memory 120, but not needed for interpolation, may be discarded by video decoder 110.

Table 8 is a table illustrating the total latency associated with motion compensation system 100 when obtaining pixel data from memory areas 122 associated with reference data block 1110 using the memory access patterns described in FIGS. 11b, 11c, 11d, and 11e. As shown in Table 8, the latency associated with reading the pixel data is calculated based on the latency associated with reading each memory area 122 (i.e., 1 clock cycle), referred to as an incremental read (e.g., INCR64read, INCR16read, INCR50read, INCR2read, INCR3read, etc.), and the bus latency associated with each continuous memory read (e.g., 17 clock cycles). In the embodiment of FIGS. 11b, 11c, 11d, and 11e, two hundred and six memory areas 122 are read in nine continuous memory reads. Thus, in one exemplary embodiment, a total latency of 359 cycles may be achieved.

TABLE 8
Latency in a Macro Block-Based System (16 × 16 pipeline)

| Illustrative | | Latency |
|---|---|---|
| Figure | Description | (Cycles) |
| 11b | Continuous read 1130a (INCR64read + Bus | 81 |
| | Latency = 64 + 17) | |
| 11c | Continuous read 1130b (INCR16read + Bus | 33 |
| | Latency = 16 + 17) | |
| 11d | Continuous read 1130c (INCR16read + Bus | 33 |
| | Latency = 16 + 17) | |
| 11e | Continuous read 1130d (INCR2read + Bus | 19 |
| | Latency = 2 + 17) | |
| 11e | Continuous read 1130e (INCR50read + Bus | 67 |
| | Latency = 50 + 17) | |
| 11e | Continuous read 1130f (INCR2read + Bus | 19 |
| | Latency = 2 + 17) | |
| 11e | Continuous read 1130g (INCR3read + Bus | 20 |
| | Latency = 3 + 17) | |
| 11e | Continuous read 1130h (INCR50read + Bus | 67 |
| | Latency = 50 + 17) | |
| 11e | Continuous read 1130i (INCR3read + Bus | 20 |
| | Latency = 3 + 17) | |
| | TOTAL LATENCY | 359 |

The disclosed embodiments may be implemented within any video coding technology, protocols, or standards. For example, motion compensation system 100 may be configured to operate according to the systems and methods of the disclosed embodiments. In this manner, the disclosed embodiments may reduce the number of memory access cycles associated access of external memory 120 and improve processing time in H.264/AVC video coding systems.

It will be apparent to those skilled in the art that various modifications and variations can be made in the system and method for bandwidth optimized motion compensation memory access. It is intended that the standard and examples be considered as exemplary only, with a true scope of the disclosed embodiments being indicated by the following claims and their equivalents.

What is claimed is:

1. A method for providing access to video data, comprising:
providing a memory device having a plurality of memory areas;
receiving a data sequence containing the video data of a plurality of blocks of a video image frame;
storing the video data in the memory device by allocating a plurality of pixel data groups along a frame-width direction in consecutive memory-addressing areas; and
allowing access to the video data in response to a data access request.

2. The method of claim 1, wherein each of the pixel data groups comprises data for at least two pixels arranged in a direction that traverses the frame-width direction.

3. The method of claim 1, wherein each of the plurality of pixel data groups comprises data for four pixels.

4. The method of claim 1, wherein the memory device has a memory bus-width of n bits and each of the pixel data groups comprises n bits of pixel data.

5. The method of claim 1, further comprising reorganizing the data sequence based on a sequence having the pixel data groups arranged in the frame-width direction.

6. The method of claim 1, wherein each of the plurality of blocks is a block having a size of one of 16 by 16, 16 by 8, 8 by 16, 8 by 8, 8 by 4, 4 by 8, and 4 by 4 pixels.

7. The method of claim 1, wherein the access to the video data comprises access to at least one data block of the video image frame and neighboring pixel data.

8. A system for providing access to video data, the system comprising:
a memory device having a plurality of memory areas;
a data-receiving interface configured to receive a data sequence containing the video data of a plurality of blocks of a video image frame; and
a memory controller coupled with the data-receiving interface and the memory device, the memory controller being configured to store the video data in the memory device by allocating pixel data groups along a frame-width direction in consecutive memory-addressing areas.

9. The system of claim 8, wherein the memory controller is further configured to provide access to the video data in response to a data access request.

10. The system of claim 9, wherein the access to the video data comprises access to at least one data block of the video image frame and neighboring pixel data.

11. The system of claim 8, wherein each of the pixel data groups comprises data for at least two pixels arranged in a direction that traverses the frame-width direction.

12. The system of claim 8, wherein each of the pixel data groups comprises data for one pixel.

13. The system of claim 8, wherein the memory device has a memory bus-width of n bits and each of the pixel data groups comprises n bits of pixel data.

14. The system of claim 8, further comprising a buffer coupled with the memory controller, the buffer being configured for buffering the video data to allow a reorganization of the data sequence based on a sequence having the pixel data groups arranged in the frame-width direction.

15. The system of claim 8, wherein each of the plurality of blocks is a block having a size of one of 16 by 16, 16 by 8, 8 by 16, 8 by 8, 8 by 4, 4 by 8, and 4 by 4 pixels.
